(19) United States
(12) Patent Application Publication
(10) Pub. No.: US 2012/0226682 A1
(43) Pub. Date: Sep. 6, 2012

(54) PROVIDING SEARCH INFORMATION

(75) Inventor: Yongliang Li, Hangzhou (CN)

(73) Assignee: ALIBABA GROUP HOLDING LIMITED, George Town (KY)

(21) Appl. No.: 13/349,308

(22) Filed: Jan. 12, 2012

(30) Foreign Application Priority Data
Jan. 14, 2011 (CN) 201110008525.6

(51) Int. Cl. G06F 17/30

(52) U.S. Cl. 707/723; 707/769; 707/E17.014

(57) ABSTRACT

Providing search information is disclosed, including: receiving one or more user input search keywords; automatically determining a plurality of search channels based at least in part on the one or more user input search keywords; searching the determined plurality of search channels for information that is relevant to the one or more user input search keywords; and returning relevant information associated with the determined plurality of search channels.

### CROSS REFERENCE TO OTHER APPLICATIONS

This application claims priority to People's Republic of China Patent Application No. 201110008525.6 entitled METHOD AND DEVICE FOR PROVIDING INFORMATION filed Jan. 14, 2011 which is incorporated herein by reference for all purposes.

### FIELD OF THE INVENTION

The present application relates to the field of information processing technology. In particular, it relates to providing search results.

### BACKGROUND OF THE INVENTION

Due to the vast amount of information that is available on the Internet, search engines websites are used to assist users in finding the information that they want. Typically, when a user desires to search for a certain piece of information, he or she can input search keywords at an input window of the search engine website and the search engine can search for information that is relevant to the search keywords. The information that is deemed relevant is returned to the user as search results.

Currently, there are at least two types of search engines: comprehensive/general search engines and vertical search engines. Typically, comprehensive search engines use the following technique of providing information to users: once the comprehensive search engine receives search keywords, it searches through all information that has been indexed, without regard to the type/category of information. Then, the comprehensive search engine returns the subset of all indexed information that it has found to be relevant back to the user. Typically, vertical search engines use the following technique of providing information to users: prior to performing a search, the search engine divides all of its indexed information into various search channels, where each search channel includes content associated with a particular type/category/segment. When a user wishes to search for information, the user can select one search channel in which the search engine is to perform the search. Then, the user inputs one or more search keywords that the vertical search engine will use to search among the information within the selected search channel. The vertical search engine returns the subset of the information included within the selected search channel that it has found to be relevant to the search keywords.

Searching with a vertical search engine is more precise because it can be conducted within information of a specific type. This way, the search engine can automatically preclude information that the user has already designated to not be relevant (e.g., the information associated with the unselected search channels). Due to its precision, many websites provide users with information using vertical searches. For example, some e-commerce websites divide its product-based information into a product channel and a seller-based information into a seller channel. So when users need to search for product-type information (e.g., model, manufacturer, product specifications), they can select to conduct their searches in the product channel and when they need to search seller-based information (e.g., seller's identity, products associated with a particular seller), they can select to conduct their searches in the seller channel.

Conventionally, a website with a vertical search engine might include several possible search channels, but a user can select one search channel in which to search at a time. Therefore, when a user is uncertain of the type of information that he or she needs to search, he or she might need to perform several searches, each with a different search channel, until the desired information is found.

So, while a vertical search engine could eventually provide a user with helpful information, the user might not be able to find the needed information in an efficient manner.

### BRIEF DESCRIPTION OF THE DRAWINGS

Various embodiments of the invention are disclosed in the following detailed description and the accompanying drawings.

FIG. 1 is a diagram of a system for providing search information.

FIG. 2 is a flow diagram showing an embodiment of a process for determining corresponding relationships between search keywords and search channels.

FIG. 3 is a flow diagram showing an embodiment of a process for providing information in response to search queries.

FIG. 4 is a flow diagram of an embodiment of determining and searching among search channels.

FIG. 5 is a diagram of an embodiment of a system for determining and searching among search channels.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Providing search information is disclosed. In various embodiments, a subset of all available search channels is automatically selected for a search based on the user input search keywords. A search channel, which is sometimes called a vertical, refers to a subset of online content that relates to a particular genre type/content type/topic. For example, a search engine that is configured to search among search channels has access to indices related to each particular search channel. For example, a search channel that comprises a product channel associated with an e-commerce website could include web content (e.g., web pages that feature products that are available for sale) that is related to different products that are offered at the website. In another example, a search channel that comprises a company channel associated with an e-commerce website could include web content (e.g., web pages that include various products sold by a particular company) that is related to various companies that offer products and/or other information at the website. In various embodiments, a genre type/content type/topic of a webpage can be identified by a tag and a webpage can be associated with one or more such tags (i.e., the same webpage can belong to more than search channels). So, if the product channel were searched, then the search engine would search through the indexed webpages included in the product channel and if the company channel were searched, then the search engine would search through the indexed webpages included in the company channel. In some embodiments, the selected search channels are selected based on stored corresponding relationships between keywords and search channels. In some embodiments, the selected search channels comprise supplementary search channels that are selected based on the user input search keywords and data that are preset for the search channels. In some embodiments, determined search channels comprise search channels that are determined by predictive rules. Once the plurality of search channels is determined, the information included in those determined search channels is searched to find information that matches/is relevant to the search keywords.

By automatically determining/selecting search channels that are determined to be relevant to a particular search, the searching user is spared the uncertainty and hassle of having to select a search channel himself/herself and the searching system is spared the inefficiency of having to search among irrelevant search channels. In this way, the searching is efficient for being conducted within those search channels that are automatically determined to be relevant but the searched information is not limited to just one type that may or may not be relevant for the user.

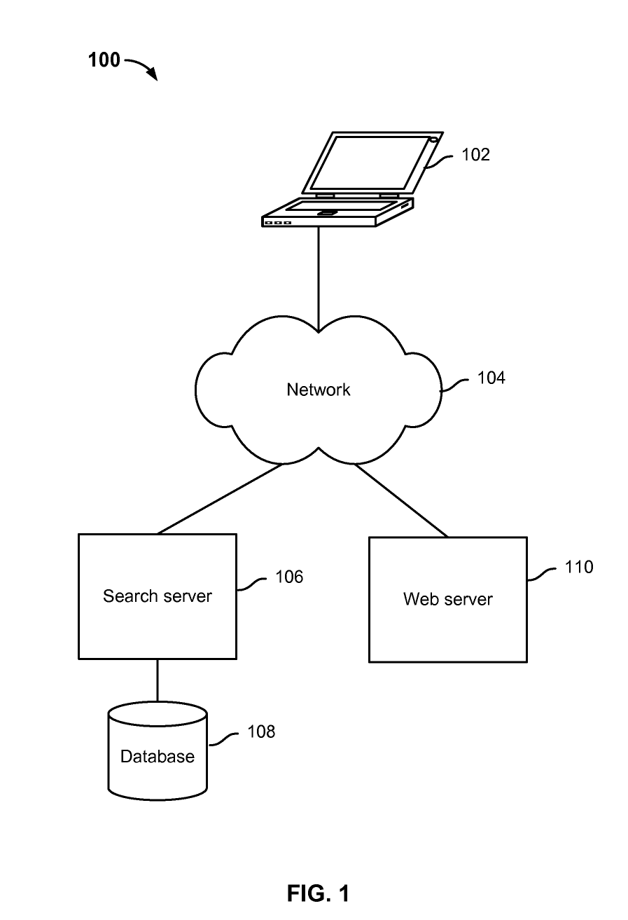

FIG. 1 is a diagram of a system for providing search information. System 100 includes device 102, network 104, search server 106, database 108, and web server 110. In some embodiments, network 104 is implemented using high-speed data networks and/or telecommunications networks. In some embodiments, search server 106 and web server 110 are configured to work separately but coordinate with each other and in some embodiments, search server 106 and web server 110 are configured to work in combination. In some embodiments, web server 110 supports a website and/or a search engine.

Examples of device 102 include a laptop computer, a desktop computer, a smart phone, a mobile device, a tablet device or any other computing device. Device 102 is configured to communicate with search server 106. In various embodiments, an application such as a web-browser is installed at device 102 to enable communication with search server 106. For example, a user at device 102 can access a website associated with/hosted by web server 110 by entering a certain uniform resource locator (URL) at the web browser address bar. For example, web server 110 can be associated with an electronic commerce website. A user can submit a search query that includes one or more search keywords at device 102 to search server 106. In some embodiments, search server 106 can store information regarding various users' searching histories. For example, search server 106 can store historical search information (e.g., in database 108) such as which search channels the users selected, which search keywords they used with which search channels, and whether they clicked on any of the search results returned from selected search channels. In some embodiments, search server 106 is configured to generate and store corresponding relationships between search keywords and search channels based on the historical search information. As will be discussed in further detail below, search server 106 is configured to use at least the stored corresponding relationships to automatically determine the plurality of search channels in which to search for information relevant to a subsequent user's input search keywords. In various embodiments, the search channels are automatically determined/selected using the user input search keywords such that the user no longer needs to designate which search channel that he or she thinks might be relevant to his or her search. In some embodiments, search server 106 is configured to search for relevant information within the determined search channels. Device 102 can also display the search results returned from search server 106.

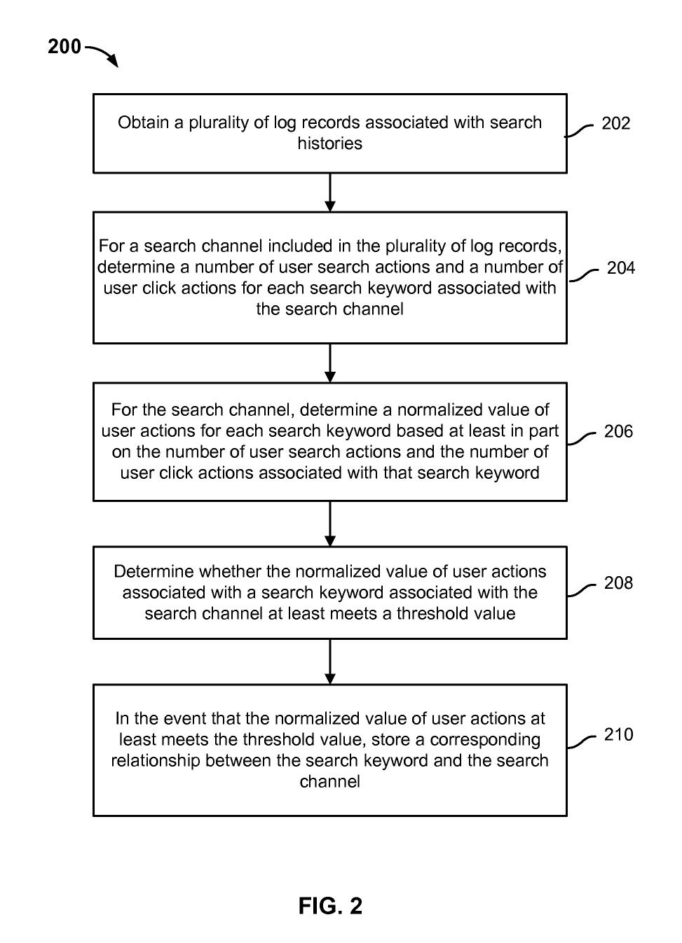

FIG. 2 is a flow diagram showing an embodiment of a process for determining corresponding relationships between search keywords and search channels. In some embodiments, process 200 is implemented at system 100.

At 202, a plurality of log records associated with search histories is obtained.

In some embodiments, the search histories of various users at a search engine is continuously stored as log records. This historical user search data can then be used to determine corresponding relationships between search keywords and search channels. For example, each log record can indicate which search channel was selected by a user, which search keywords the users input for searching under the selected search channel, and whether if any of the search results returned for the search was actually selected by the user (e.g., the search results can comprise a list of links and a user can select a link by clicking on it with a cursor). In some embodiments, the log records are timestamped with the time at which the searches were conducted. In some embodiments, log records associated with a particular range of time (e.g., a previous day, a previous week, a previous month) are used to determine the corresponding relationships between search keywords and search channels

The following is an example technique by which a log record can be made: when a user inputs search keywords for one search channel associated with a search engine to conduct a search, the web browser records this search action by the user in the log records. For example, the web browser records the search channel in which the search was conducted, the search keywords used, and a user action label with respect to the search. The user action label refers to one of many possible user actions with respect to the search. In this example, the label of “offerclick” indicates a user click action that includes the user clicking on at least one search result returned from the search channel and the label of “search” indicates a user search action that includes the user following through with submitting the search keywords of his/her search query but not clicking on any of the search results.

Table 1 below shows an example of entries recorded within the log records. In Table 1, the leftmost column indicates the type of search channel in which the search was made, the middle column indicates the search keywords that were input by the user, the rightmost column indicates the user action labels. Each row entry in Table 1 records the user-selected search channel, the search keywords used in the historical search, and an associated user action label for the historical search.

TABLE 1

| Search channel | Search keywords | User action label |
|---|---|---|
| Product channel | Mobile phone | search |
| Business channel | MP3 | offerclick |

At 204, for a search channel included in the plurality of log records, a number of user search actions and a number of user click actions are determined for each search keyword associated with the search channel.

In some emboidments, the search keywords included in the stored log records (e.g., associated with a particular time range) are first processed using a standardization treatment. The standardization treatment refers to one or more known techniques that can be used to eliminate unnecessary words, eliminate extra spaces, convert letters to either all upper-case or all lower-case, convert Chinese characters into either all simplified or traditional characters, eliminate punctuation marks, and convert any numerical formats as necessary, for example.

For each search channel included in the log records, the number of user search actions and the number of user click actions that are associated with each keyword are determined by, for example, programmatically tallying the total number of user click actions and the total number of user search actions for each keyword that is associated with a search channel as indicated in a table such as Table 1.

At 206, for the search channel, a normalized value of user actions is determined for each search keyword based at least in part on the number of user search actions and the number of user click actions associated with that search keyword.

A normalized value of user actions of a search keyword associated with a search channel refers to a value that is determined using both of the user search actions and user click actions associated with that search keyword. For example, each user click action can be translated into twice the value that is associated with each user search action (e.g., based on the presumption that there is greater user interest in a search result if the user actually clicks on it).

For example, the number of search actions for the search keyword “mobile phone” associated with the product search channel is 3 and the number of click actions is 4. If the value of each user search action were 1 and if the value of each user click action were twice the value of the user search action, then the value of each user click action is 2. Thus, then the normalized value of user actions for the search keyword “mobile phone” associated with the product search channel is: 3*1+4*2=11.

At 208, is it determined whether the normalized value of user actions associated with a search keyword associated with the search channel at least meets a threshold value.

In some embodiments, a threshold value is set such that only search keywords associated with normalized numbers of user actions that meet or exceed the threshold value can be used for determining corresponding relationships with its search channel. For example, the threshold value can be preset or determined dynamically by a system administrator.

If the normalized value of user actions for some search keywords with respect to certain search channels is very small (i.e., below the threshold value), then that indicates that fewer users pay attention to these search keywords with respect to these search channels. To increase processing efficiency and to save website storage space, a system adminstrator can determine a threshold value and store only the corresponding relationships between search keywords and those search channels whose normalized number of actions is greater than this threshold value. For example, assume that the threshold value is 3. If the normalized number of actions of the search keyword “mobile phone” for the company search channel is 2, which is less than the threshold value of 3, then the corresponding relationship between search keyword “mobile phone” and the company search channel is not stored.

At 210, in the event that the normalized value of user actions at least meets the threshold value, a corresponding relationship is stored between a search keyword associated with the search channel and the search channel.

For example, the corresponding relationships between search keywords and search channels can be stored as shown in Table 2:

TABLE 2

| Search keywords | Search channel |
|---|---|
| Mobile phone | Product channel |
| | seller channel |
| MP3 | Business channel |
| | Product channel |

In Table 2, each search channel is identified by a string (e.g., “product channel”) or series of characters. In other embodiments, each search channel can also be represented by a numerical identifier. For example, if the product channel can be represented by preset number value identifier 14, the seller channel by preset number value identifier 5, and the business channel by preset number value identifier 4, then the information of Table 2 can be represented by Table 3, as shown below:

TABLE 3

| Search keyword | Search channels |
|---|---|
| Mobile phone | 14 |
| | 5 |
| MP3 | 4 |
| | 14 |

In another example, the corresponding relationships between search keywords and search channels can be stored with the normalized value of user actions associated with that search keyword with respect to that search channel. An example of this is shown in Table 4 below:

TABLE 4

| | | Normalized value of user |
|---|---|---|
| Search keyword | Search channel | actions |
| Mobile phone | 14 | 5 |
| | 5 | 10 |
| MP3 | 4 | 4 |
| | 14 | 8 |

In another example, the corresponding relationships between search keywords and search channels are stored with the normalized value of user actions associated with that search keyword with respect to that search channel and for each seach keyword, its corresponding search channels are ranked based on their normalized value of user actions. For example, a search channel with a higher value for the normalized value of user actions is stored in a higher row in a table than another search channel with a lower value for the normalized value of user actions. An example of this is shown in Table 5 below:

TABLE 5

| | | Normalized value of user |
|---|---|---|
| Search keywords | Search channel | actions |
| Mobile phone | 5 | 10 |
| | 14 | 5 |
| MP3 | 14 | 8 |
| | 4 | 4 |

In some embodiments, once corresponding relationships between search keywords and search channels are automatically determined and stored such as by using the techniques described above, a system administrator may manually adjust any of the stored corresponding relationships. For example, in the corresponding relationships shown in Table 5, the search channels corresponding to the search keyword “mobile phone” are product channel and seller channel. System administrators can adjust the above corresponding relationships manually. For example, the system administrators adjust the values of Table 5 so that search keyword “mobile phone” corresponds to the business channel and the product channel instead, as shown in Table 6 below:

TABLE 6

| | | Normalized value of user |
|---|---|---|
| Search keywords | Search channel | actions |
| Mobile phone | 4 | 10 |
| | 14 | 5 |

In some embodiments, the manually adjusted stored corresponding relationships are stored with the original, automatically generated ones (i.e., so there is just one set of stored corresponding relationships). In some embodiments, the manually adjusted corresponding relationships are stored separately from the original, automatically generated ones (i.e., so there are two sets of stored corresponding relationships, one automatically generated and one manually adjusted). While Table 6 stores the manually adjusted corresponding relationships, Table 7 below stores the corresponding relationships between search keyword “MP3” and search channels that were not manually adjusted:

TABLE 7

| | | Normalized value of user |
|---|---|---|
| Search keyword | Search channels | actions |
| MP3 | 14 | 8 |
| | 4 | 4 |

In some embodiments, the corresponding relationships as described above can be (but is not limited to being) stored in the form of a two-level index. For example, a first-level index indicates the initial position of each search keyword in the second-level index. The search channels corresponding to the search keywords in the second-level index are looked up on the basis of the initial positions as indicated in the first-level index.

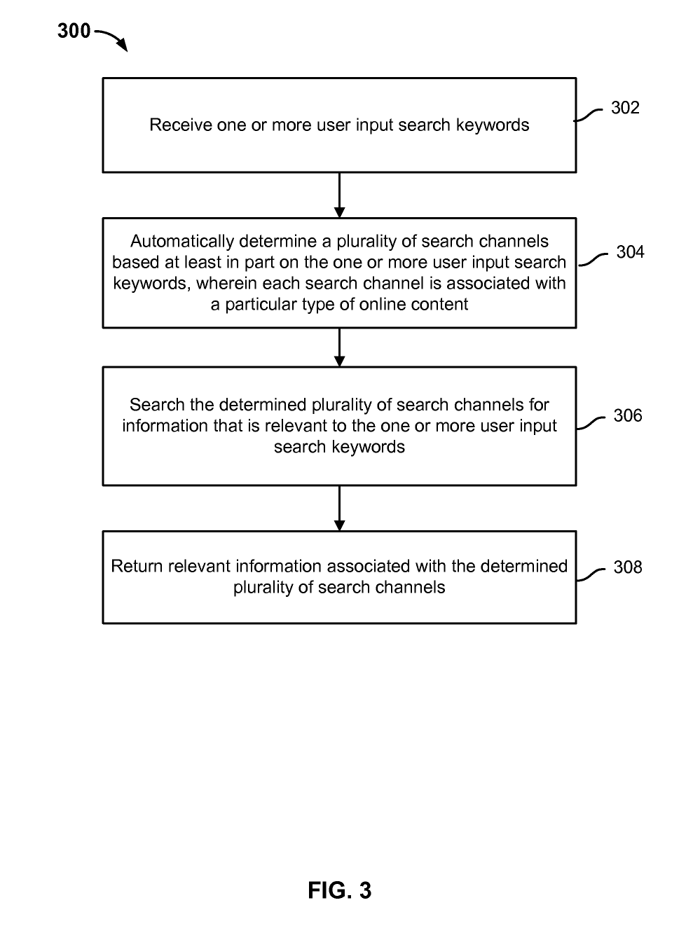

FIG. 3 is a flow diagram showing an embodiment of a process for providing information in response to search queries. In some embodiments, process 300 is performed at system 100.

In some embodiments, process 300 is implemented in association with a search engine at a website.

At 302, one or more user input search keywords are received.

When a user searches for information on a website, he or she can input keywords that comprise a search query in a search window that is displayed on the search engine's webpage as viewed via a browser. In some embodiments, the search engine website can process the user input search keywords using a standardization treatment. The standardization treatment refers to techniques including eliminating unnecessary words, eliminating extra spaces, converting letters to either all upper-case or all lower-case, converting Chinese characters into either all simplified or traditional characters, elimninating punctuation marks, converting any numerical formats as necessary, etc.

At 304, a plurality of search channels is automatically determined based at least in part on the one or more user input search keywords, wherein each search channel is associated with a particular type of online content.

In various embodiments, the plurality of search channels is determined by using the stored corresponding relationships between search keywords and search channels. Examples of search channels may be associated with an e-commerce website and may include a product channel, a business channel, a seller channel, a company channel, and/or another channel related to another type of online content (e.g., topic associated with a webpage). For example, stored corresponding relationships between search keywords and search channels can be determined by a process such as process 200. In some embodiments, search channels are selected based on data associated with the search channels and/or rules. Then, information associated with the selected search channels are to be searched and those that match the user input search keywords will be provided to the user.

To determine search channels using stored corresponding relationships, the user input search keywords are compared against those search keywords that are included in the stored corresponding relationships (either the original, automatically generated ones and/or the manually adjusted ones) and once matching search keywords in the stored information are found, the search channels corresponding to those matched search keywords are considered to be determined search channels. For example, if the user input search keyword was “MP3,” then Table 5 (above) can be searched to find stored corresponding relationships between search keyword “MP3” and search channels 4 (business channel) and 14 (product channel).

In some embodiments, alternatively or in addition to selecting search channels based on stored corresponding relationships, search channels can be determined by comparing the preset lexical item sets associated with search channels to the user input search keywords. These determined search channels are sometimes herein referred to as “first supplementary search channels.” An example of determining a first supplementary search channel is discussed in 404 of process 400. In some embodiments, in storage, each search channel is associated with a preset set of lexical items.

In some embodiments, alternatively or in addition to selecting search channels based on stored corresponding relationships and/or by comparing the preset lexical sets associated with search channels to the user input search keywords, search channels can be determined by comparing the attribute information of user input search keywords to preset attribute information associated with search channels. These determined search channels are sometimes herein referred to as “second supplementary search channels.” An example of determining a second supplementary search channel is discussed in 406 of process 400. In some embodiments, in storage, each search channel is associated with a preset set of attribute identifiers.

In some embodiments, the one or more user input search keywords are compared to one or more special search keyword rules to determine a “third supplementary search channel.” An example of determining a third supplementary search channel is discussed in 408 of process 400. In some embodiments, in storage, one or more special search keyword rules are each assoicated with a designated search channel.

In some embodiments, in the event that a search channel is not determined using the stored plurality of corresponding relationships, a first supplementary search channel is not determined, a second supplementary search channel is not determined, and a third supplementary search channel is not determined, a predictive rule is used to determine a search channel. An example of determining a search channel using a predictive rule is discussed in 410 of process 400. In some embodiments, in storage, one or more predictive rules are each associated with a designated search channel.

At 306, the determined plurality of search channels is searched for information that is relevant to the one or more user input search keywords.

In some embodiments, the determined search channels include any search channels determined using stored corresponding relationships between search keywords and search channels, using preset lexical item sets (first supplementary search channels), using preset attribute identifiers (second supplementary search channels), using special search keyword rules (third supplementary search channels), and/or using predictive rules.

For example, if the determined search channels for the user input search keyword “mobile phone” are the product channel and the business channel, then the information associated with the product channel and the business channel are searched either together (e.g., the content associated with both search channels are first combined and then searched) or separately (e.g., the content associated with each search channel is searched separately) for information that is relevant to the user input search keywords.

At 308, relevant information associated with the determined plurality of search channels is returned.

In some embodiments, the information found to be relevant to the one or more user input search keywords are presented to the searching user as search results at a webpage. For example, a search result may comprise a link to a webpage associated with a product. In some embodiments, the search results are presented without being ranked. In some embodiments, the search results are first ranked and then presented. An example process of providing the found information that includes ranking the information can be, but is not limited to the following:

First, the normalized value of user actions associated with the one or more user input search keywords for each determined search channel is determined (e.g., from the stored information). Then, search results are ranked based on the normalized value of user actions associated with the search channel and the search results associated with the search channel associated with the greatest normalized value of user actions are presented first (e.g., highest among a list of search results), then those with the search channel associated with the second greatest normalized value of user actions, and so forth.

For example, assume that the determined search channels for the search keyword “mobile phone” are the product channel, company channel, seller channel, and business channel. The normalized value of user actions for “mobile phone” associated with the product channel is 10; for “mobile phone” associated with the company channel is 8; for “mobile phone” associated with the seller channel is 6; and for “mobile phone” associated with the business channel is 4. As such, the search results found from the information associated with the product channel is ranked first, followed in sequence by the search results information found in the information associated with the company channel, the search results information found in the information associated with the seller channel, and the search results information found in the information associated with the business channel.

In some embodiments, in order to help the user better use the returned search results, the number of search results found from the information associated with each determined search channel is presented next to an identifier associated with each search channel. In some embodiments, the identifier of each determined search channel is presented as a link with the number of search results found from the information associated with that search channel and, upon a user selection of the link, the search results associated with that search channel will be displayed.

Below is an example of a table-based presentation of various determined search channels and their respective number of search results. As shown below in Table 8, the number of search results found from the information associated with the product channel is 50; number of search results found from the information associated with the company channel is 40; number of search results found from the information associated with the seller channel is 30; and number of search results found from the information associated with the business channel is 20.

TABLE 8

| Product channel | Company channel | Seller channel | Business channel |
|---|---|---|---|
| (50) | (40) | (30) | (20) |

In some embodiments, if any one of the first, second, and/or third supplementary search channels are used in the determined search channels through which relevant information was found, then the search results found from information associated with the supplementary search channels can be ranked at the top of the ranked search results presented to the user.

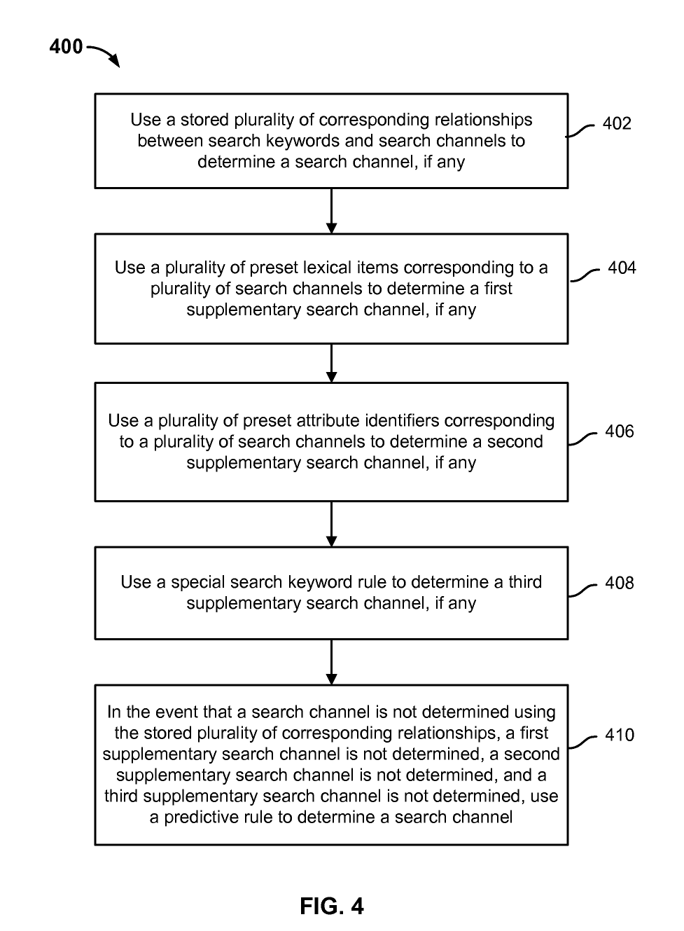

FIG. 4 is a flow diagram of an embodiment of determining and searching among search channels. In some embodiments, 306 is implemented using process 400. In some embodiments, process 400 is implemented at system 100.

At 402, a stored plurality of corresponding relationships between search keywords and search channels is used to determine a search channel, if any. As discussed above for 306 of process 300, the plurality of search channels can be determined by matching the user input search keywords of a search query against the search keywords of stored corresponding relationships. Then, the search channels corresponding to the matched search keywords are considered as determined search channels whose associated information is going to be used for searching with respect to the user input search keywords.

At 404, a plurality of preset lexical items corresponding to a plurality of search channels is used to determine a first supplementary search channel, if any.

In some embodiments, 404 is optionally performed to determine a first supplementary search channel that is used to search for information, in addition to the search channels, if any, determined at 402. The first supplementary search channel, if determined, can expand the scope of search of the user input search keywords by adding another search channel through which relevant search results may be found.

In some embodiments, search channels can be determined by comparing the preset lexical sets associated with search channels to the user input search keywords. A lexical item refers to a single word or a series of words that convey a single meaning (e.g., “cat,” “traffic light,” “take care of”). For example, a system administrator can input the associated set of lexical items for each search channel. The lexical items input for each search channel may be relevant to that search channel and different search channels may be associated with different lexical items. For example, lexical items associated with the product channel can include terms associated with different product categories, such as “music,” “mp3,” “CD,” “electronics,” “books,” “DVDs,” and “apparel,” among many others. To determine first supplementary search channels, the user input search keywords are compared against each of the preset lexical item sets and when the user input search keywords match one or more lexical items in a set, then the search channel corresponding to the matching lexical item set is determined to be a first supplementary search channel.

The following is an example of determining matches between the user input search keywords and sets of lexical items associated with search channels to determine first supplementary search channels:

The one or more user input search keywords are segmented into individual keyword units (i.e., each search keyword will form its own keyword unit). Then, a known technique of matching search keyword units against lexical items that are associated with search channels is used. The technique may include a preset search keyword unit matching sequence that determines a sequence in which each subsequent search keyword unit among the search keyword units is selected for comparison against lexical items and also determines a sequence in which each lexical item set associated with search channels is compared (e.g., the sequence can be “business channel,” seller channel,” “product channel,” “company channel,” and then “purchase offer channel”). For example, one search keyword unit is selected at a time and used to match against each lexical item within the lexical item set associated with each search channel. If a match is found between the search keyword unit and a lexical item of a set, then the matching process ends. Otherwise, the next search keyword unit is selected and used to match against each lexical item within the lexical item set associated with each search channel. The search channel that is associated with the lexical item that matched a search keyword unit is then determined to be the first supplementary search channel. In some embodiments, if the first supplementary search channel is already one of the search channels determined by using stored corresponding relationships, then information from the first supplementary search channel will not be searched because it would be redundant to do so.

For example, assume that the user input search keyword comprises “quality MP3.” So the individual search keyword units are “quality” and “MP3.” Assume that the available search channels are “business channel,” “seller channel,” “product channel,” “company channel,” and “purchase channel.” In this example, the search keyword “quality” is selected first and is compared with the lexical items included in the lexical item sets associated with each search channel. If “quality” is found to match a lexical item in the lexical item sets associated with a particular search channel, then the matching is stopped and the particular search channel is determined to be the first supplementary search channel. However, if “quality” is not found to match any lexical item in the lexical items associated with any search channel, then the next search keyword unit, “MP3,” is selected and used for further comprison.

At 406, a plurality of preset attribute identifiers corresponding to a plurality of search channels is used to determine a second supplementary search channel, if any.

In some embodiments, 406 is optionally performed to determine a second supplementary search channel that is used to search for information, in addition to the search channels determined at 402 and/or the first supplementary search channel determined at 404. The second supplementary search channel, if determined, can also expand the scope of search of the user input search keywords by adding another search channel through which relevant search results may be found. In some embodiments, 406 is performed only if 404 fails to determine a first supplementary search channel (i.e., the search keyword units did not match the lexical items associated with the search channels).

The following is an example of determining matches between the user input search keywords and the preset attribute identifier patterns associated with search channels to determine second supplementary search channels:

The one or more user input search keywords are segmented into individual keyword units (i.e., each search keyword will form its own keyword unit) and an attribute type is determined for each search keyword unit. Returning to the previous example, where the search keyword units comprise “quality” and “MP3,” the attribute for search keyword unit “quality” would be “modifier” and the attribute for search keyword unit “MP3” would be “product word.” Then, based on preset rules, a corresponding attribute identifier is found for each search keyword unit based on that search keyword unit's type of attribute. However, not every type of attribute has a designated attribute identifier. For example, the attribute identifier that is designated for the attribute of “product word” is “CP,” but there is no attribute identifier for the attribute of a “modifier.” Thus, the set of attribute identifiers of user input search keywords “quality MP3” is simply “CP” because the search keyword unit “quality” is not associated with an attribute identifier and the search keyword unit “MP3” is associated with the attribute identifier of “CP.” Since there are preset attribute identifiers associated with each search channel (e.g., the attribute identifier associated with the product channel is “CP”), a search channel can be identified based on its associated preset attribute identifier. The set of attribute identifiers associated with the search keyword units are compared with the preset attribute identifiers of the search channels and if there is a match, then the search channel associated with the matching preset attribute identifiers is considered as a second supplementary search channel. In some embodiments, if the second supplementary search channel is already one of the search channels determined by using stored corresponding relationships and/or the preset sets of lexical items, then information from the second supplementary search channel will not be searched because it would be redundant to do so.

For example, assume that in the preset rules, the attribute identifier for the attribute of “administrative district word” (e.g., of a search keyword unit such as “Hangzhou City”) is “QH,” the attribute identifier for the attribute of “brand word” (e.g., of a search keyword unit such as “Haier”) is “PP,” the attribute identifier for the attribute of “model number word” (e.g., of a search keyword unit such as “3250”) is “XH,” the attribute identifier for the attribute of “product word” (e.g., of a search keyword unit such as “MP3”) is “CP,” the attribute identifier when the attribute of “institution word” (e.g., of a search keyword unit such as “People's Procuratorate”) is “JG,” the attribute identifier for other attribute types is “##,” and those search keyword units whose attribute is a modifier are not associated with an attribute identifier. So, if the user input search keywords are “Hangzhou City Wahaha address,” then the corresponding attribute identifiers comprise “QHPP##.” If the user input search keywords are “Nokia3250,” then the corresponding attribute identifiers comprise “PPXH.” If the user input search keywords are “Nokia mobile phone,” then the corresponding attribute identifiers comprise “PPCP.” If the user input search keywords are “Zhejiang leather shoes,” then the corresponding attribute identifiers comprise “QHCP.” If the user input search keywords are “Hangzhou Alibaba,” then the corresponding attribute identifiers comprise “QHJG.” If the user input search keywords are “Zhejiang Province Hangzhou City Xihu District,” then the corresponding attribute identifiers comprise “QHQH.” In this example, the product channel is associated with attribute identifiers “PPXH,” “PPCP,” or “QHCP,” and so if the user input search keywords are associated with any one of those sets of attribute identifiers, then the product channel will be determined as the second supplementary search channel. And the company channel is associated with attribute identifiers “QHPP,” “QHJG,” or “QHQH,” and so if the user input search keywords are associated with any one of those sets of attribute identifiers, then the company channel will be determined as the second supplementary search channel. The specific attribute identifiers are chosen for purposes of illustration and other identifiers may be used in different embodiments.

At 408, a special search keyword rule is used to determine a third supplementary search channel, if any.

In some embodiments, 408 is optionally performed to determine a third supplementary search channel that is used to search for information, in addition to the search channels determined at 402 and/or the first and second supplementary search channels determined at 404 and 406. The third supplementary search channel, if determined, can also expand the scope of search of the user input search keywords by adding yet another search channel through which relevant search results may be found.

In some embodiments, one or more special search keyword rules are designated (e.g., by the system administrator) and are associated with particular search channels. So, if it is determined that any of the one or more user input search keywords meet the conditions of a rule, then the particular search channel(s) associated with the matching rule will be determined as a third supplementary search channel whose associated information is going to be used for searching with respect to the user input search keywords (in addition to the determined search channels determined in 402, first supplementary search channel determined in 404, and second supplementary search channel determined in 406). In some embodiments, if the third supplementary search channel is already one of the search channels determined by using stored corresponding relationships and/or the preset sets of lexical items and/or preset attribute identifiers, then information from the third supplementary search channel will not be searched because it would be redundant to do so.

For example, a special search keyword rule could be that if a search keyword includes the characters associated with an Internet web address (e.g., if the search keyword started with “http://,” or “www.,” or ended with “.com,”), then the product channel associated with the search keyword will be determined as a third supplementary search channel. In another example, a special search keyword rule could be if the user input search keyword includes a telephone number, then the company channel will be determined as a third supplementary search channel. In another example, a special search keyword rule could be if the user input search keyword is an English and number combination (e.g., “ndst-730”), then the product channel will be determined as a third supplementary search channel. In another example, a special search keyword rule could be if the attribute of the last search keyword unit among the user input search keywords is a product word, a brand word, or a model number word, then the product channel will be determined as a third supplementary search channel. In another example, a special search keyword rule could be if the user input search keyword has only one search keyword unit, and this keyword unit is a product word or a modifier, then the product channel will be determined as a third supplementary search channel. Or, in another example, a special search keyword rule could be if the last search keyword unit has the attribute of a product word, then the company channel will be determined as a third supplementary search channel.

At 410, in the event that a search channel is not determined using the stored plurality of corresponding relationships, a first supplementary search channel is not determined, a second supplementary search channel is not determined, and a third supplementary search channel is not determined, a predictive rule is used to determine a search channel.

In some embodiments, 410 is optionally performed to determine a search channel that is used to search for information, if any of the techniques described in 402, 404, 406, and 408 above fail to determine a search channel through which relevant search results may be found. Thus, 410 can be performed last, if applicable, to determine at least one search channel through which relevant information can be provided. In some embodiments, if at least one search channel has been determined by any one or more of 402, 404, 406, and 408, then 410 is not performed.

In some embodiments, if no search channels are determined using stored corresponding relationships in 402, no first supplementary search channels are determined in 404, no second supplementary search channels are determined in 406, and no third supplementary search channels are determined in 408, then a technique for predicting a relevant search channel is performed. The technique for predicting a relevant search channel may include one or more predictive rules (e.g., set by system administrators), which are applied to the one or more user input search keywords.

For example, a predictive rule can be that if an attribute associated with the keyword units of the user input search keywords is a product word, a brand word, or a model number word, then the product channel will be determined as a search channel. And if the attribute associated with the search keyword units are associated with any other attribute, then the business channel will be determined as the search channel.

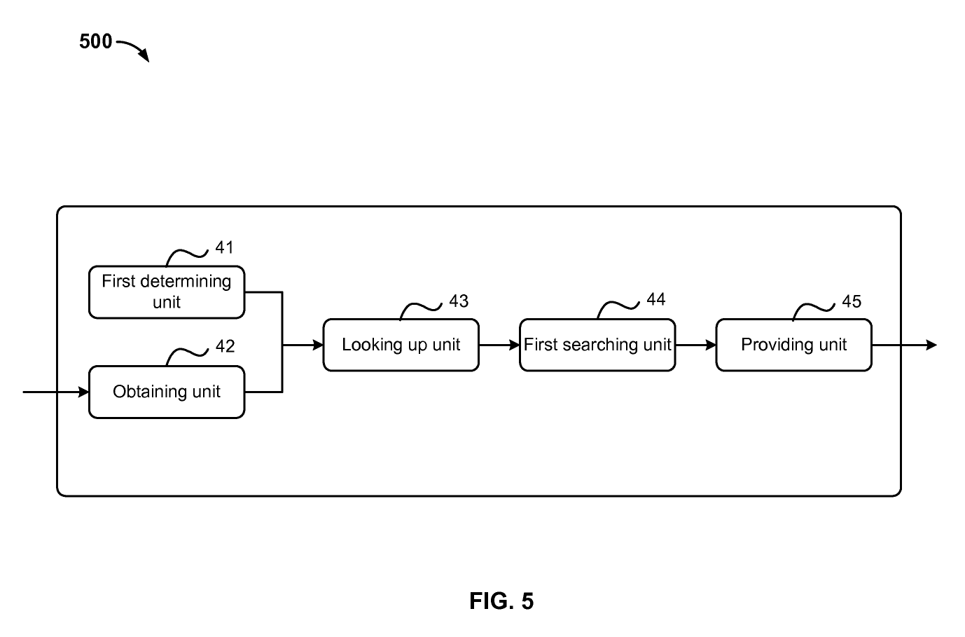

FIG. 5 is a diagram of an embodiment of a system for determining and searching among search channels. In some embodiments, search server 106 is implemented with system 500. In the example, system 500 includes first determining unit 41, obtaining unit 42, looking up unit 43, first searching unit 44, and providing unit 45.

The units and subunits can be implemented as software components executing on one or more processors, as hardware such as programmable logic devices, and/or Application Specific Integrated Circuits designed to perform certain functions, or a combination thereof. In some embodiments, the units and subunits can be embodied by a form of software products which can be stored in a nonvolatile storage medium (such as optical disk, flash storage device, mobile hard disk, etc.), including a number of instructions for making a computer device (such as personal computers, servers, network equipment, etc.) implement the methods described in the embodiments of the present invention. The units and subunits may be implemented on a single device or distributed across multiple devices.

First determining unit 41 is configured to determine the corresponding relationships between search keywords and search channels. In some embodiments, first determining unit 41 is also configured to store such corresponding relationships so that they can be used later to assist in providing search results.

Obtaining unit 42 is configured to receive user input search keywords. For example, the user input search keywords can be submitted by a user at a website that includes a search engine.

Looking up unit 43 is configured to look up, based on the user input search keywords received by obtaining unit 42, and among the corresponding relationships between the search keywords and the search channels determined by first determining unit 41, the search channels that correspond to the received user input search keywords.

First searching unit 44 is configured to search among the information associated with each search channel determined by looking up unit 43 for the information relevant to the user input search keywords received by obtaining unit 42.

Providing unit 45 is configured to provide relevant information found by first searching unit 44 to users.

In some embodiments, system 500 further includes a second determining unit, a first assessing unit, a third determining unit, and a second searching unit. The second determining unit is configured to determine from among the preset lexical item sets associated with search channels, the lexical items that match the user input search keywords obtained by obtaining unit 42. The first assessing unit is configured to determine whether the search channels that are associated with the matching lexical item sets are already included in the search channels determined by looking up unit 43. The third determining unit is configured to determine that if the assessment result of the first assessing unit is negative, then the search channels associated with the matching lexical item sets are deemed to be first supplementary channels (because such search channels have not yet been determined). The second searching unit is configured to search from among information included in the first supplementary search channel(s), as determined by the third determining unit, the information that is relevant to the user input search keywords obtained by obtaining unit 42. In some embodiments, providing unit 45 is configured to provide to users information found by first searching unit 44 in information associated with each search channel as determined by looking up unit 43 and information found by the second searching unit in information associated with the first supplementary search channels as determined by the third determining unit.

In some embodiments, a second determining unit comprises a dividing sub-unit, a selecting sub-unit, a looking up sub-unit, and a first determining sub-unit. The dividing sub-unit is configured to segment the user input search keywords obtained by obtaining unit 42 into individual keyword units. The selecting sub-unit is configured to select a first search keyword unit based at least in part on a preset keyword unit matching sequence, and when the looking up sub-unit fails to find a matching lexical item from a preset set of lexical items associated with a search channel, to select the next search keyword unit based on the keyword matching sequence. The looking up sub-unit is configured to look up among lexical items included in the lexical item sets corresponding to search channels, lexical items that match the search keyword units selected by the selecting sub-unit; if a lexical item is found to match the selected search keyword, the looking up process is then ended. The first determining sub-unit is configured to determine the lexical items looked up by a looking up sub-unit to be the lexical items matching the search keywords.

In some embodiments, system 500 further includes a dividing unit, a fourth determining unit, a fifth determining unit, a sixth determining unit, a second assessing unit, a seventh determining unit, and a third searching unit. The dividing unit is configured to segment the search keywords received by obtaining unit 42 into search keyword units if, before providing unit 45 provides the information found by first searching unit 44 to a user, the second determining unit fails to determine a lexical item that matches the search keywords received by obtaining unit 42 from among the preset sets of lexical items associated with search channels. The fourth determining unit is configured to determine the attribute of each of the search keyword units. The fifth determining unit is configured to determine the attribute identifiers of the user input keywords based on the attribute information of the search keyword units determined by the fourth determining unit. The sixth determining unit is configured to determine search channels associated with the attribute identifiers determined by the fifth determining unit. The second assessing unit is configured to assess whether the search channels determined by the sixth determining unit are already included in the search channels looked up by looking up unit 43. Seventh determining unit is configured to determine when the assessment results of the second assessing unit are negative, and then the search channels associated with the matching attribute identifiers are deemed to be second supplementary channels (because such search channels have not yet been determined). The third searching unit is configured to search from among the information associated with second supplementary search channels, as determined by the sixth determining unit, information that is relevant to user input search keywords received by obtaining unit 42.

Providing unit 45 is configured to provide to users information found by first searching unit 44 and information found by the third searching unit.

In some embodiments, first determining unit 41 is configured to include an obtaining sub-unit, a second determining sub-unit, a third determining sub-unit, and a fourth determining sub-unit. The obtaining sub-unit is configured to obtain log records associated with a particular length of time. For example, the log records search keywords and associated search channels and also associated user actions (e.g., search actions and click actions). The second determining sub-unit is configured to determine, with respect to each search keyword included in the log records, search keywords and associated search channels and the associated number of search actions and number of click actions for each search channel. The third determining sub-unit is configured to determine, with respect to each search keyword included in the log records, the normalized value of user actions associated with search keywords with respect to each search channel. The fourth determining sub-unit is configured to determine, with respect to each search keyword included in the log records, the search channel, whose normalized value of user actions is greater than a threshold value, to be the search channel that has a corresponding relationship to the search keyword.

In some embodiments, providing unit 45 includes a fifth determining sub-unit, a ranking sub-unit, and a providing sub-unit. The fifth determining sub-unit is configured to determine the normalized value of user actions associated with each user input search keyword received by obtaining unit 42 with respecte to each search channel. The ranking sub-unit is configured to rank information relevant to the user input search keywords found within the determined search channels based on the normalized value of user actions associated with each determined search channel. A providing sub-unit is configured to provide the information ranked by the ranking sub-unit to users.

A person skilled in the art should understand that the embodiments of the present application can be provided as methods, devices (equipment), or computer software products. Therefore, the present disclosure can take the form of embodiments consisting entirely of hardware, embodiments consisting entirely of software, and embodiments which combine software and hardware. In addition, the present application can take the form of computer programs implemented on one or more computer-operable storage media (including but not limited to magnetic disk storage devices, CD-ROMs, and optical storage devices) containing computer program codes.

The present application is described with reference to flow charts and/or block diagrams based on methods, devices (equipment), and computer program products. It should be understood that each process and/or block in the flow charts and/or block diagrams, and combinations of processes and/or blocks in the flow charts and/or block diagrams, can be achieved through computer program commands. One can provide these computer commands to a general-purpose computer, a specialized computer, an embedded processor or the processor of other programmable data equipment so as to give rise to a machine, with the result that the commands executed through the computer or processor of other programmable data equipment give rise to a device that is used to realize the functions designated by one or more processes in a flow chart and/or one or more blocks in a block diagram.

These computer program commands can also be stored on specially-operating computer-readable storage devices that can guide computers or other programmable data equipment, with the result that the commands stored on these computer-readable devices give rise to products that include command devices. These command devices realize the functions designated in one or more processes in a flow chart and/or one or more blocks in a block diagram.

These computer program commands can also be loaded onto a computer or other programmable data equipment, with the result that a series of operating steps are executed on a computer or other programmable equipment so as to give rise to computer processing. In this way, the commands executed on a computer or other programmable equipment provide steps for realizing the functions designated by one or more processes in a flow chart and/or one or more blocks in a block diagram.

Although preferred embodiments of the present application have already been described, a person skilled in the art can make other modifications or revisions to these embodiments once he grasps the basic creative concept. Therefore, the attached claims are to be interpreted as including the preferred embodiments as well as all modifications and revisions falling within the scope of the present application. Obviously, a person skilled in the art can modify and vary the present application without departing from the spirit and scope of the present invention. Thus, if these modifications to and variations of the present application lie within the scope of its claims and equivalent technologies, then the present application intends to cover these modifications and variations as well.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method of providing search information, comprising:
receiving one or more user input search keywords;
automatically determining a plurality of search channels based at least in part on the one or more user input search keywords, wherein each search channel is associated with a particular type of online content;
searching the determined plurality of search channels for information that is relevant to the one or more user input search keywords; and
returning relevant information associated with the determined plurality of search channels.

2. The method of claim 1, wherein returning relevant information includes ranking one or more search results associated with each of the plurality of search channels.

3. The method of claim 2, wherein one or more search results associated with each of the plurality of search channels are ranked based at least in part on a normalized value of user is actions associated with each search channel.

4. The method of claim 1, wherein automatically determining a search channel includes using a stored plurality of corresponding relationships between search keywords and search channels.

5. The method of claim 4, wherein in the event that one of the user input search keywords matches a search keyword included in the stored plurality of corresponding relationships, a search channel in the stored plurality of corresponding relationships associated with the matched search keyword comprises one of the determined plurality of search channels.

6. The method of claim 1, further comprising:
obtaining a plurality of log records associated with search histories;
determining, for a search channel included in the plurality of log records, a number of user search actions and a number of user click actions for each search keyword associated with that search channel;
determining, for the search channel included in the plurality of log records, a normalized value of user actions for each search keyword based at least in part on the number of user search actions and the number of user click actions associated with that search keyword;
determining whether the normalized value of user actions associated with a search keyword associated with the search channel included in the plurality of log records at least meets a threshold value; and
in the event that the normalized value of user actions at least meets the threshold value, storing a corresponding relationship between the search keyword and that search channel.

7. The method of claim 1, wherein automatically determining the plurality of search channels includes:
using a stored plurality of corresponding relationships between search keywords and search channels to determine a search channel, if any;
using a plurality of preset lexical items corresponding to a plurality of search channels to determine a first supplementary search channel, if any;
using a plurality of preset attribute identifiers corresponding to a plurality of search channels to determine a second supplementary search channel, if any;
using a special search keyword rule to determine a third supplementary search channel, if any; and
in the event that a search channel is not determined using the stored plurality of corresponding relationships, a first supplementary search channel is not determined, a second supplementary search channel is not determined, and a third supplementary search channel is not determined, using a predictive rule to determine a search channel.

8. The method of claim 7, further comprising segmenting the one or more user input search keywords into one or more individual search keyword units.

9. The method of claim 1, wherein the determined plurality of search channels comprises one or more of the following: a search channel determined based at least in part on a stored plurality of corresponding relationships between search keywords and search channels, a first supplementary search channel, a second supplementary search channel, a third supplementary search channel, and a search channel determined based on a predictive rule.

10. A system for providing search information, comprising:
a processor configured to:
receive one or more user input search keywords;
automatically determine a plurality of search channels based at least in part on the one or more user input search keywords, wherein each search channel is associated with a particular type of online content;
search the determined plurality search channels for information that is relevant to the one or more user input search keywords; and
return relevant information associated with the determined plurality of search channels; and
a memory coupled to the processor and configured to provide the processor with instructions.

11. The system of claim 10, wherein to return relevant information includes ranking one or more search results associated with each of the plurality of search channels.

12. The system of claim 11, wherein one or more search results associated with each of the is plurality of search channels are ranked based at least in part on a normalized value of user actions associated with each search channel.

13. The system of claim 10, wherein to automatically determine a plurality of search channels includes using a stored plurality of corresponding relationships between search keywords and search channels.

14. The system of claim 13, wherein in the event that one of the user input search keywords matches a search keyword included in the stored plurality of corresponding relationships, then a search channel in the stored plurality of corrsponding relationships associated with the matched search keyword comprises one of the determined plurality of search channels.

15. The system of claim 10, wherein the processor is further configured to:
obtain a plurality of log records associated with search histories;
determine, for a search channel included in the plurality of log records, a number of user search actions and a number of user click actions for each search keyword associated with that search channel;
determine, for the search channel included in the plurality of log records, a normalized value of user actions for each search keyword based at least in part on the number of user search actions and the number of user click actions associated with that search keyword;
determine whether the normalized value of user actions associated with a search keyword associated with the search channel included in the plurality of log records at least meets a threshold value; and
in the event that the normalized value of user actions at least meets the threshold value, store a corresponding relationship between the search keyword and that search channel.

16. The system of claim 10, wherein to automatically determine the plurality of search channels includes the processor configured to:
use a stored plurality of corresponding relationships between search keywords and search channels to determine a search channel, if any;
use a plurality of preset lexical items corresponding to a plurality of search channels to determine a first supplementary search channel, if any;
use a plurality of preset attribute identifiers corresponding to a plurality of search channels to determine a second supplementary search channel, if any;
use a special search keyword rule to determine a third supplementary search channel, if any; and
in the event that a search channel is not determined using the stored plurality of corresponding relationships, a first supplementary search channel is not determined, a second supplementary search channel is not determined, and a third supplementary search channel is not determined, use a predictive rule to determine a search channel.

17. The system of claim 16, wherein the processor is further configured to segment the one or more user input search keywords into one or more individual search keyword units.

18. The system of claim 10, wherein the determined plurality of search channels comprises one or more of the following: a search channel determined based at least in part on a stored plurality of corresponding relationships between search keywords and search channels, a first supplementary search channel, a second supplementary search channel, a third supplementary search channel, and/or a search channel determined based on a predictive rule.

19. A computer program product for providing search information, the computer program product being embodied in a non-transitory computer readable storage medium and comprising computer instructions for:
receiving one or more user input search keywords;
automatically determining a plurality search channels based at least in part on the one or more user input search keywords, wherein each search channel is associated with a particular type of online content;
searching the determined plurality of search channels for information that is relevant to the one or more user input search keywords; and
returning relevant information associated with the determined plurality of search channels.
